(19) United States
(12) Patent Application Publication
(10) Pub. No.: US 2013/0253889 A1
(43) Pub. Date: Sep. 26, 2013

(54) MODELING AND SIMULATION CAPABILITY FOR RESOURCE CONSUMPTION AND CONSEQUENCE MANAGEMENT

(71) Applicant: Mid-Atlantic Technology, Research & Innovation Center, Inc., (US)

(72) Inventors: David Victor Baker, Morgantown, WV (US); Aaron Allyn Barkhurst, Morgantown, WV (US); Mark Alan Dehlin, Morgantown, WV (US); Timothy Patrick Jones, JR., Morgantown, WV (US); Matthew Ryan Moyles, Morgantown, WV (US)

(73) Assignee: Mid-Atlantic Technology, Research & Innovation Center, Inc., South Charleston, WV (US)

(21) Appl. No.: 13/787,321

(22) Filed: Mar. 6, 2013

Related U.S. Application Data
(60) Provisional application No. 61/607,090, filed on Mar. 6, 2012.

(51) Int. Cl. G06F 17/50

(52) U.S. Cl. CPC G06F 17/5009
USPC 703/6

(57) ABSTRACT

The present invention regards modeling and simulation (M&S) capability for resource consumption and consequence management. Embodiments of the system assist emergency planners, government officials, medical professionals, academics and others to prepare for disasters and other emergency events requiring mass evacuation or transportation of people. The system can be used for evacuation, flood and fire modeling, terrorist attacks, military logistics, mail and package delivery, urban planning, supply chain modeling, disaster recovery, animal migration, weather patterns and even in modeling the spread of infectious disease. The system of the present invention is highly extensible and scalable.

### GENERAL BACKGROUND

The present invention regards modeling and simulation (M&S) capability for resource consumption and consequence management. Embodiments of the system assist emergency planners, government officials, medical professionals, academics and others to prepare for disasters and other emergency events requiring mass evacuation or transportation of people. The system can be used to plan for evacuation and resource consumption modeling for events such as: flood, fire, terrorist attacks. The system can also be applied to military logistics, mail and package delivery, urban planning, supply chain modeling, disaster recovery, animal migration, weather patterns and even in modeling the spread of infectious disease. The system of the present invention is highly extensible and scalable.

Specifically, one embodiment of the M&S capability of the present invention enables emergency planners to design and run dynamic, time-aware “what-if” simulations depicting the impacts of a mass evacuation of a location or region defined by the user upon transportation and other critical infrastructure and the corresponding resource consumption during an emergency, allowing the user to understand the consequences of allocating and deploying limited supplies.

This embodiment simulates the impact of evacuees on the transportation infrastructure and the consumption of resources (e.g., fuel, water, first aid, and shelter). The simulation logic of the present invention utilizes user-driven scenario parameters including, for example, the number of consumers evacuating (or entering) an area, the percent seeking shelter, average gallons of water or other resource used per consumer, and designated points of ingress/egress in a transportation network. The simulation then generates interactive, time-aware maps and reports. Further, the system of the present invention compares simulations to facilitate sensitivity analysis and allow a user to evaluate the impact of input parameters on simulation output.

During the simulation users can modify scenario parameters and activate and deactivate providers (e.g., shelters), place and remove barriers in the transportation network (e.g., dams to simulate floods, clots to simulate medical conditions, intentional fires to control the spread of fires, etc.), and enforce resource rationing (e.g., fuel) using simulation tools; upon such modifications, the system will reroute consumers and calculate resource consumption based upon the modified user plan, and display time-aware results. Activation of providers (such as shelters and first aid) have a startup and per consumer cost which are deducted from a “war chest” designed and defined by the user for the particular simulation.

Simulation results including resource consumption and transportation network congestion are visualized using an intuitive “time aware” map that displays the consumption of critical resources over time and provides users the ability to pause, playback, fast forward, and rewind the simulation. Each time interval (e.g., a minute) indicates the status of the consumers and resources at that interval. Additionally, users can generate reports for specific resources (e.g., fuel, hospital bed availability over time), or broader reports encompassing all resources and their depletion rates.

The present invention allows users to create unlimited user-defined scenarios and response plans; to implement, refine and practice response plans to improve policy; to identify resource staging and sharing opportunities and shortages; and to improve response times and reduce costs through enhanced planning.

The interactive system of the present invention integrates geographic information system (GIS) technologies and non-GIS technologies. GIS technologies include real-world data (e.g., location, roads, bridges, etc.), analytical tools (e.g.,resource consumption simulation, routing logic), application program interfaces (APIs) (e.g., HTML5, JavaScript, C#, Python, ArcGIS API), as well as simulation based on modeling each individual resource consumption behaviors based on subject matter expertise guidance and user input parameters. Maps are incorporated into the system, which may include transportation networks (roads, rivers, veins) and provider locations (e.g., fuel stations, shelters, hospitals, National Guard locations, emergency operation centers, dams, marshes, and human organs).

Embodiments of the present invention are provided by means of a browser based portal, and use Flex application framework (open source) or HTML5 and JavaScript, C# and Python, with ArcGIS systems offered by ESRI, although other presentation means, framework tools and mapping and analysis systems may be suitable for use with the present invention.

### FIGURES

FIG. 1 is a diagram of event creation workflow of an embodiment of the present invention.

FIG. 2 is a diagram of the time-aware interaction between the user and the system pursuant to an embodiment of the present invention.

FIG. 3 shows an overall class diagram of various features of an embodiment of the present invention.

FIG. 4 shows an entity relationship diagram based upon consumption, in accordance with an embodiment of the present invention.

FIG. 5 shows an entity relationship diagram with user and system interaction, in accordance with an embodiment of the present invention.

FIG. 6 shows a design for activating a provider (shelter) of an embodiment of the present invention.

FIG. 7 shows prioritization tree creation for dynamic route processing of an embodiment of the present invention.

FIG. 8 shows a flex viewer management window of an embodiment of the present invention.

FIG. 9 shows a flex viewer live maps window of an embodiment of the present invention.

FIG. 10 shows generally the system design of an embodiment of the present invention.

FIG. 11 shows the selection of a provider for generating reports, in accordance with an embodiment of the present invention.

FIG. 12 shows the details of a provider available to a user at a time stamp during the simulation, in accordance with an embodiment of the present invention.

FIG. 13 shows a comparison report between two simulations run, in accordance with an embodiment of the present invention.

FIG. 14 shows the selection of a region for running the simulation, in accordance with an embodiment of the present invention.

FIG. 15 shows field mapping for external data in accordance with an embodiment of the present invention.

FIG. 16 shows an interactive temporal or time-based simulation map including road congestion and resource consumption based upon the scenario parameters, in accordance with an embodiment of the present invention.

FIG. 17 shows an interactive map for creating barriers in accordance with an embodiment of the present invention.

FIG. 18 shows the interactive screen for the creation of a warchest in accordance with an embodiment of the present invention.

FIG. 19 shows the input screen for scenario parameters in accordance with an embodiment of the present invention.

FIG. 20 shows the system interface upon completion of the simulation, in accordance with an embodiment of the present invention.

Table 1 shows exemplary parameters of embodiments of the present invention; table 2 shows exemplary resource field information.

### DETAILED DESCRIPTION

The system of the present invention includes a user interface, geoprocessing services and database storage and retrieval systems. The system includes a web based user interface that enables users to log into the system, create new simulations by entering scenario parameters, launch simulations, review simulation results, modify simulations and generate reports. Users visualize the scenario in multi-dimensional space (e.g., 3-dimensional, 2.5-dimensional, stereoscopic or 2-dimensional) or in reports using text or charts. The system may be loaded on or viewed on a desktop, laptop, tablet, or other mobile platforms capable of communicating with the system's server(s).

The system of the present invention generally comprises events, consumers, providers, resources, a transportation network and a war chest. Users of the system design events in regions (geographic, human, or otherwise), consumers consume resources, providers provide resources, transportation networks provide paths for the consumers to travel on, and the warchest supplies providers. Attributes for the event, consumers, providers, transportation networks and the war chest are customizable by the user, and include data/parameters relating to resource values and consumption. Table 1 includes examples of scenario parameters used to create a simulation. The parameter list is not meant to encompass all parameters and the overall system can be extended and modified as needed.

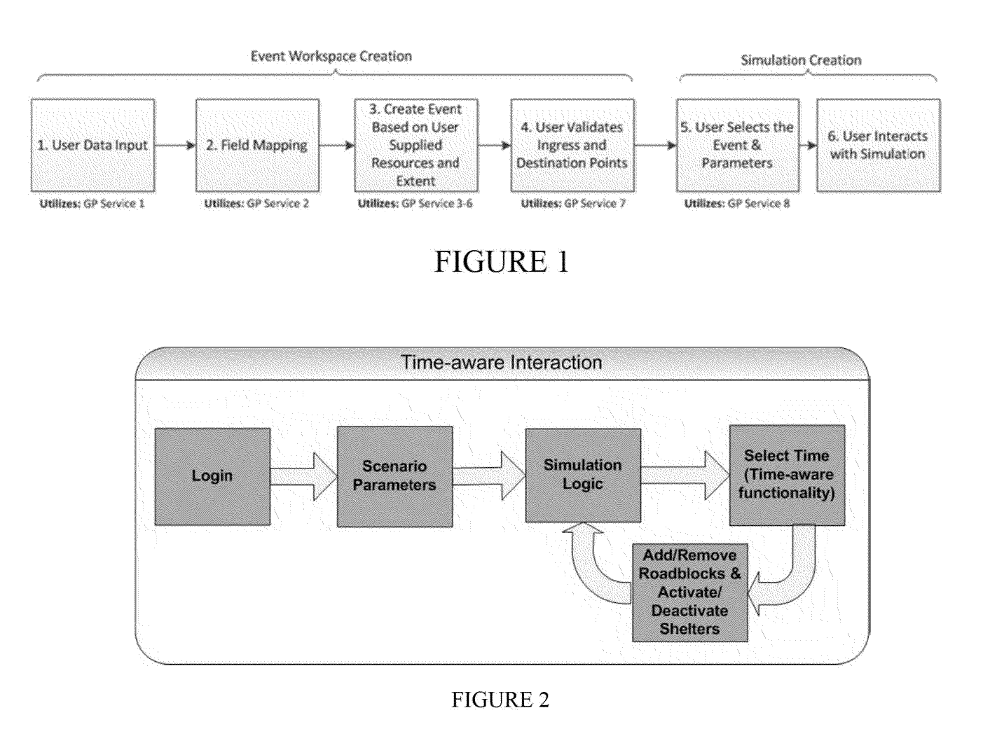

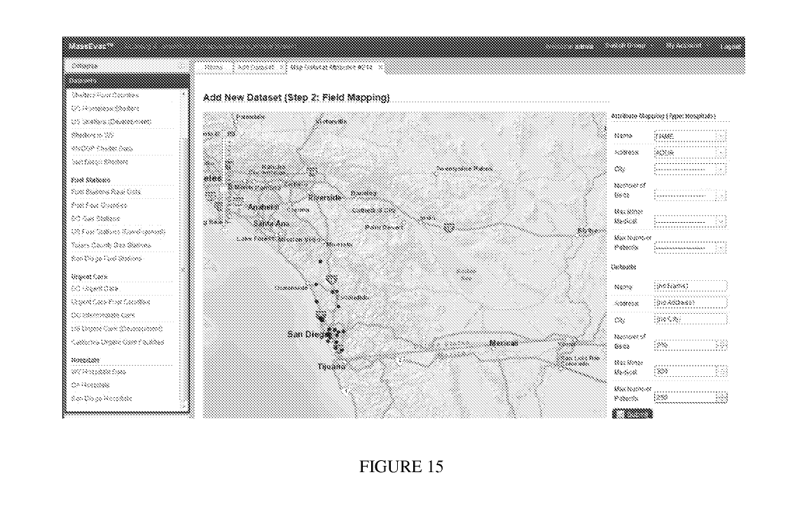

The workflow of new events using the system of the present invention is depicted in FIG. 1. Generally, new events are created by designing an event, creating a work space where data for the event is stored (including attribute parameters, transportation routes and event information, as hereinafter described) and creating a simulation of the event. Specifically, at GP Service 1, user data is input and/or retrieved from other sources into the system. This information can be collected by combining data (e.g., open geospatial consortium conformant data) from a variety of data sources including but not limited to academic, state and federal data agencies, and commercial sources. The system may also have certain data stored therein useful to a scenario. Once the user data is input and data sources are retrieved, at GP Service 2 the user may field-map the data source and the system fields, (as shown in FIG. 15) and the system can then import and ingest the data into the geo-database of the system. The system includes information for key resources (e.g. water, first aid, shelter, fuel), including location, inventory, capacity and resource specific fields. The system will also ingest real-time (streaming) data when available, including data streams from network accessible services and data files. With all of the available data entered or gathered in the system, the simulation geo-processing service is then run.

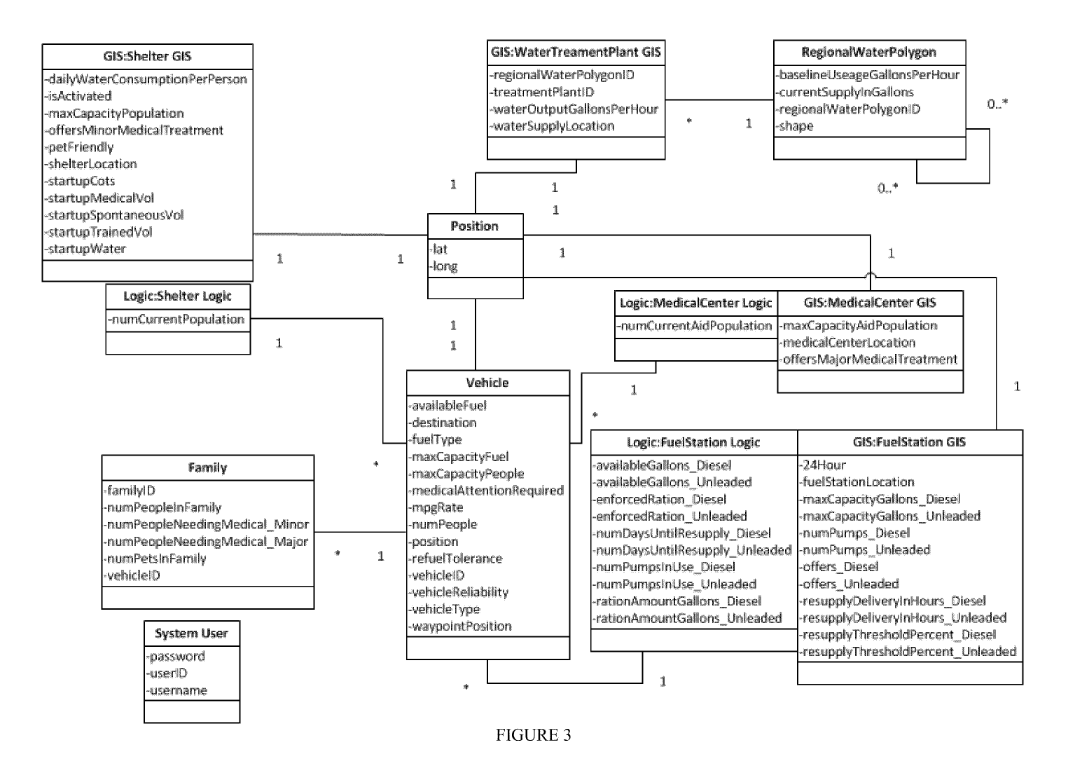

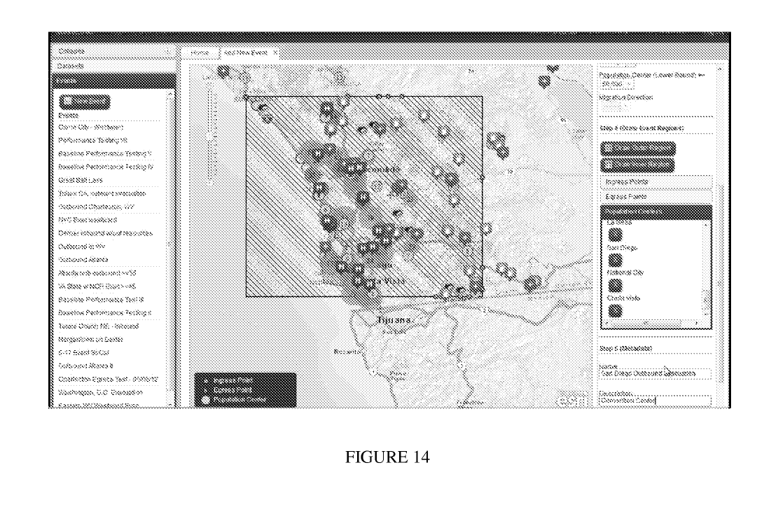

Specifically, in an embodiment of the present invention, an event causing the evacuation of a geographic region is simulated (although an evacuation is shown and described, the system of the present invention may also be used to simulate a migration to a region). As depicted in FIG. 2, the system of the present invention allows users to log into the system at a portal and select or input the event, including the time of the event, designate the geographic region (see FIG. 14) and specific event location being evacuated, and the desired geographical boundaries of the simulation (referring to FIG. 1, at GP Service 3 a road network data set (used for routing) is clipped from the road network already loaded in the system, to limit the simulation to the area of interest defined by the user, and provided at the portal to the user to allow the user to select the boundaries), resulting in the event workspace in the system to be used in the simulation. The user must choose if the event is inbound or outbound. An inbound event is where consumers are flowing into a region from external sources (e.g., evacuees leaving the National Capitol Region and entering the eastern panhandle of West Virginia). An outbound event is where the consumers are fleeing from a location or region inside of the expected hosting region (e.g., evacuees leaving the San Diego convention center area and fleeing to the surrounding county containing the convention center). The polygons required for inbound and outbound events can be provided by the user (e.g., can be drawn within the system) or can be imported from a file, tool, or service. The user is also prompted to designate the ingress or egress routes from the zone of interest; these routes may be designated by weight percentage per unit of time so that the simulation will cause the same percentage of consumers per unit of time to take a route as the designated percentage weight attributed to the route. Users could alternatively specify an equation, file, tool, or service to provide the weighting per unit of time information. This may be done by creating a zone interactively on the map provided at the portal, wherein a user creates or uploads a polygon to mark the zone, and selects the roads intersecting the polygon that will be used for ingress and egress from the evacuation zone as well as population centers meeting criteria (such as population or infrastructure requirements) specified by the user. In some embodiments users can select minimum speed for consumer travel, which can vary. When regions are selected, the system of the present invention is able to determine all roads intersecting the inner and/or outer regions by which vehicles can travel based upon the speeds previously selected by the user, and the user may select from this list those roads which will be used in the simulation.

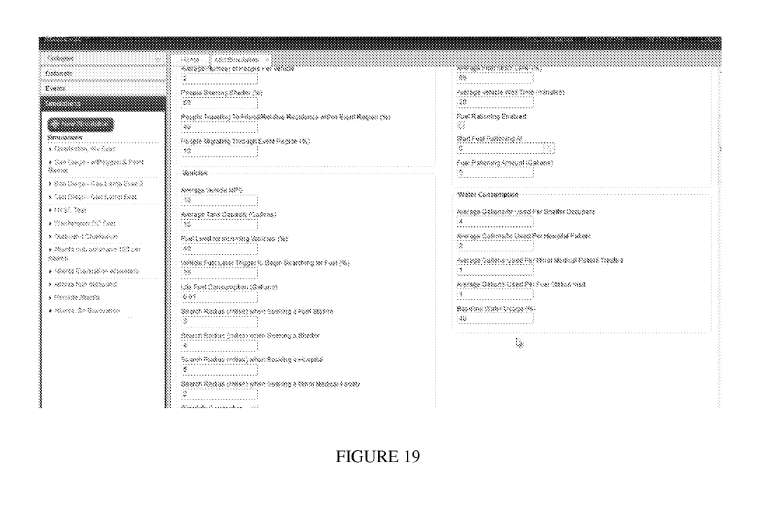

The user further inputs the number of consumers (including people and/or cars) involved in the evacuation, and the intended destinations of the consumers (surrounding populated areas where they may find residential shelter, surrounding geographic regions where they may find public shelter, and departure from the surrounding geographic regions) indicated by percentages (See, e.g., FIG. 19). The system also allows users to input percentages of people needing providers as a result of the event (e.g. percentage needing hospital, percentage needing urgent care), the number of hospital beds available and other parameters of attributes of consumers and providers. The system of the present invention further allows users to map population centers within the effected region defined by a “lower bound” (minimum population for a population center to be shown), and select or exclude any such population centers from the simulation. The percentage of consumers seeking residential shelters will be routed to travel to the population centers so indicated by the user.

The user also inputs and/or designates data regarding providers and their resources. Providers may include for example static (fixed) and impromptu (suitable facilities) shelters, fuel stations, hospitals, and urgent care facilities; providers may further include suppliers, for example fuel and water suppliers. This data may be at another computer, server or network service, or on the Internet, at a location designated by the user (e.g., URL), and may include live, simulated or historical data streams or other data. The user may also input general or default information regarding each type of provider and their resources. When information is imported into the system from another data source, the user has the ability to map the fields of information from the data source to the system of the present invention (mapping field names of the data source to field names specific to the system). Data may be accepted in multiple formats, including KML, CSV, REST, KMZ, XML & ESRI formats. Additional points of interest may be added to the providers tracked by the system of the present invention by importing geographic information regarding the same from other sources (e.g. KML locations offered by Google Maps).

Each resource is grouped by type (e.g. hospitals) and has certain attributes as defined by the system; if some of those attributes of a resource are not included in the data source (e.g., amount of fuel or water available at fuel stations), the user may enter default or formulaic values for the attributes associated with a specific resource which the system will incorporate with the third party data in performing the simulation. Attributes of a provider may include geographic location, fuel supply, fuel type, space, beds, beds available, volunteers required, water available, time necessary to become functional or provide supplies, etc. The system assigns each provider an ID. Providers may be linked to one another, wherein the ID of one provider is an attribute of another provider.

Similarly, the user inputs and/or designates data regarding consumers. Consumers may, in this embodiment, include people and vehicles; they may be further defined as “local people” and “visiting people” or in other manners to further define varying behaviors of a class of consumers. Data regarding these consumers may be designated from an external data source in like manner as the designation of external data sources for providers. Default or formulaic values may be entered by the user (or provided by the system). Attributes of a consumer may include fuel consumption, available fuel, fuel type, maximum fuel capacity, refuel tolerance and distance, vehicle reliability, vehicle type, passenger numbers, family numbers, water consumption, and anticipated medical needs. The system assigns each consumer an ID. Furthermore, like providers consumers may be linked together (e.g., linking people to vehicles, wherein an attribute of one family may be a vehicle ID).

Other parameters of the simulated event that may be input by the user and apply to the general event include a percentage of people needing medical assistance; the behavior of individuals transporting people with hospital requirements (e.g., in a vehicle, does one person stay with the injured individual, do none, or do all persons). When very specific information is available for consumers and/or providers, the present invention and some embodiments split certain providers and resources into classes (linking by ID as hereinabove described) in order to avoid overloading the database and slow down processing of the information.

For any simulation, the user may select which provider and consumer classes or groups may participate in the simulation.

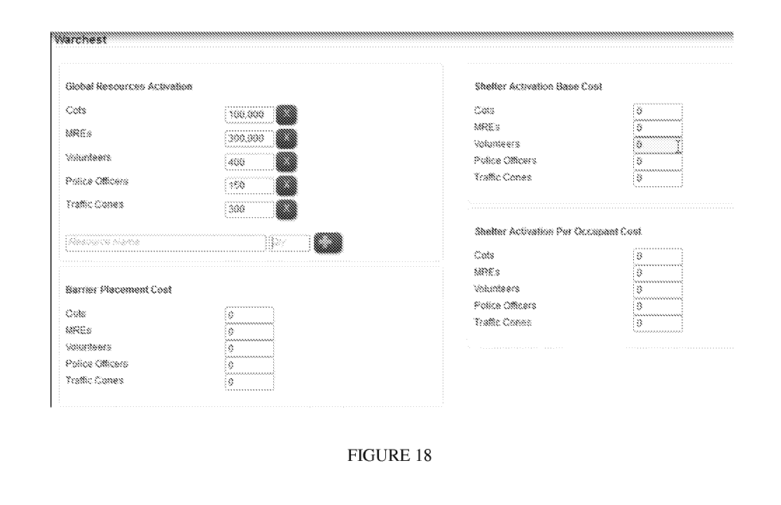

As shown in FIG. 18, the user also inputs the applicable resources of the community in a war chest, for example the number of volunteers, police officers, beds and amount of water, fuel and traffic cones available for deployment. The inventory (type of object and number of objects) contained within the war chest are completely customizable by the user. The system of the present invention then allows the user to define activation and consumer specific costs for each resource designated by the user in the warchest for activating a provider (e.g. shelter) or taking any action (e.g., barrier placement).

FIG. 3 shows an overall class diagram of the various components of this embodiment of the present invention. Specifically shown is a shelter and its attributes (associated shelter logic), a starting position, a water treatment plant, a regional water system, a medical center and an associated logic, a fuel station and its attributes (associated fuel logic), a vehicle, a family, and a system user. From this data the present invention calculates and maps the anticipated movements of these consumers along a transportation system while receiving services from these providers.

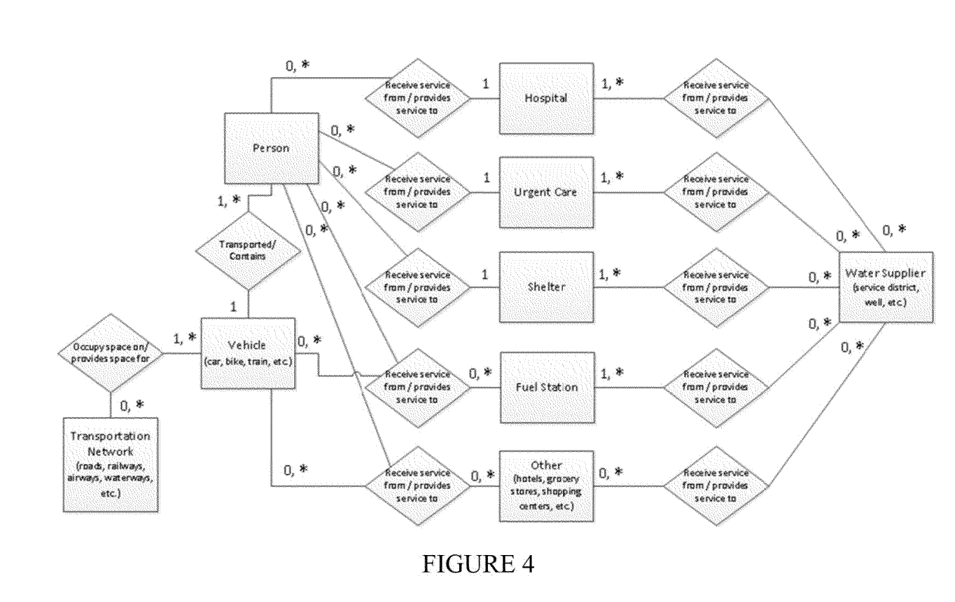

FIG. 4 shows an entity relationship diagram including consumers such as people and vehicles, a transportation network, and providers such as hospitals, urgent cares, shelters, fuel stations, hotels, grocery stores, shopping centers, etc. In this exemplary figure, also shown is a water supplier who can supply water to providers. Multiple of these consumers and providers can be included in a simulation based upon the input by the user to the system.

All of the foregoing data input or designated by the user are scenario parameters and ingested into the system of the present invention; the system may provide modifiable defaults for any attributes. Once the event and scenario parameters are entered in the portal (via data entry or import from independent dataset), the server-side simulation geoprocessing services will apply the parameters and run a time sequence of the scenario using information relating to the transportation network already gathered and stored in the system of the present invention (as hereinafter described). The system's geoprocessing services use simulation logic services hosted on an ESRI ArcGIS Server. The simulation treats consumers as intelligent agents—each of which seek out resources in accordance with the general parameters of the system. The use of intelligent agents allows the simulation to model the behavior of every individual entity in the simulation. Therefore, a consumer (e.g., a vehicle) seeking a resource (e.g., fuel) would seek such resource when it reaches its tolerance attribute (e.g., % to empty). However, while the system knows which providers (e.g., fuel stations) no longer have such resource, the intelligent agent consumer does not, and will travel to the nearest fuel station regardless of whether fuel is available at that station (although it will not receive fuel at that provider, and will have to continue seeking fuel until it finds a provider with fuel). Similarly, consumers (e.g., people) will “search” for shelters, as a human being would, rather than simply traveling to a shelter as known by the system of the present invention.

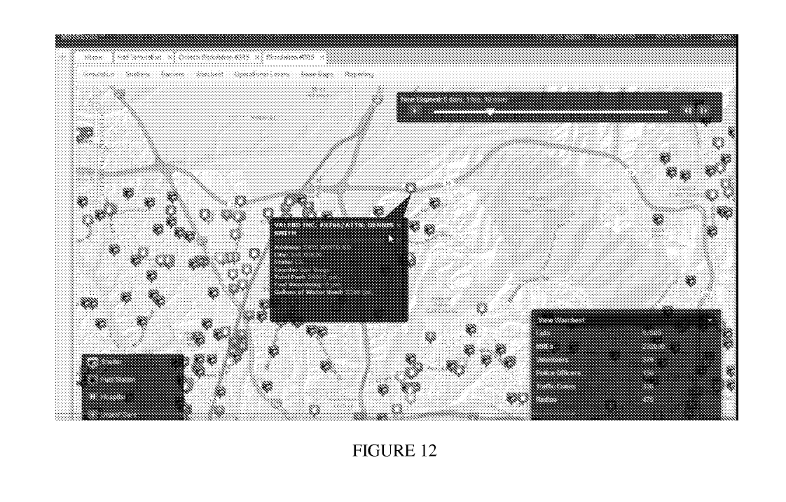

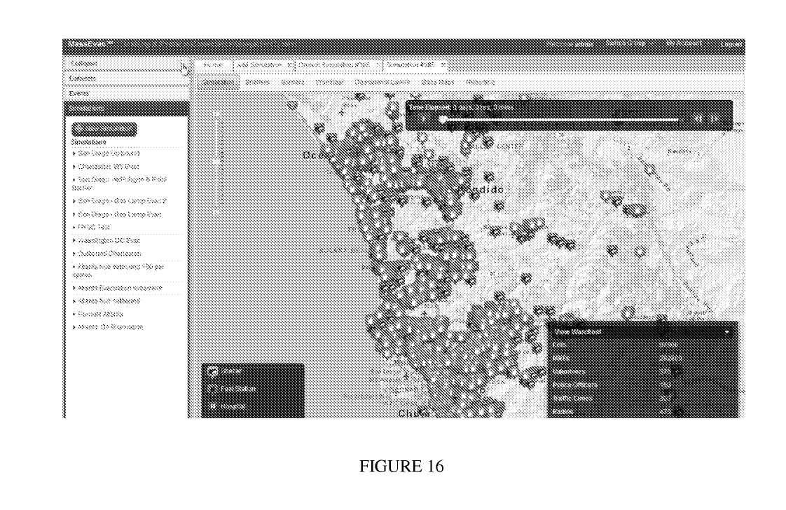

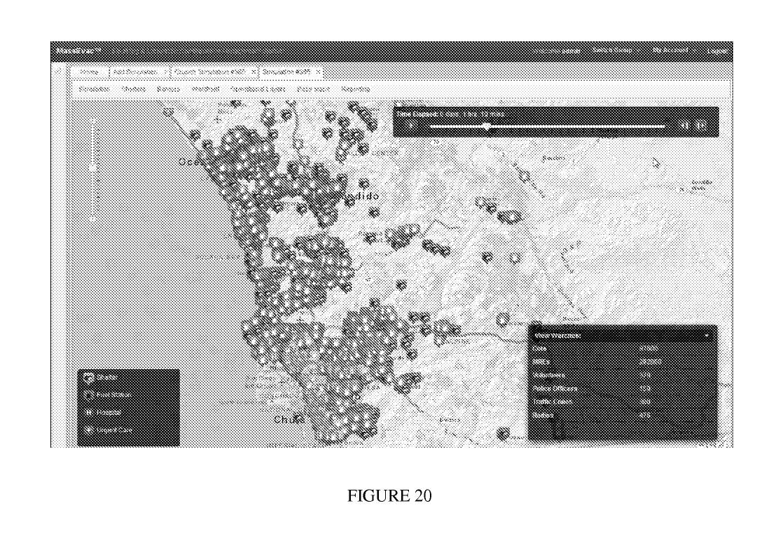

Once the simulation is complete, the system interface provides the user with an interactive temporal or time-based simulation map that will show at any time, and over time, road congestion and resource consumption based upon the scenario parameters (See, e.g., FIGS. 16, 20). The system can provide details for any intelligent agent (consumer or provider) in the simulation, and tracks their state for every time stamp. Coloration on the transportation network indicates flow levels based upon congestion modeling (e.g., red indicates stopped or slow traffic, which may be generated with raster or vector traffic heat maps). The simulated congestion is based upon road capacity and numerous vehicle time-aware attributes. Providers are shown in their geospatial location; as providers become full (e.g., shelters) or empty (e.g., fuel), they change color to indicate unavailability. Further, the system allows the user to hover over a provider to see additional attributes of the provider (see FIG. 12). Providers are preferably differentiated on the user interface by symbology and color.

Specifically, the system of the present invention tracks anticipated movement of each consumer class (e.g., vehicles, people, etc.) through the transportation network, including egress from the evacuation region and diversions as necessary to re-fuel, consume water, seek medical attention, seek shelter, etc. Resource depletion is calculated and shown real-time, with consumers consuming fuel based upon type of vehicle, distance traveled, and speed, and refueling, wherein the fuel acquired by the consumer is depleted from the provider's (fuel station) supply. Similarly, when a consumer uses a shelter or a hospital, it uses one or more beds, and the available bed count of the shelter is depleted accordingly. The consumers have tolerance attributes based upon human behavior (as input into or generated by the system) and the system will cause each consumer to seek a provider when its resources are within a percentage of depletion (e.g., may seek fuel when 20% fuel remaining). Furthermore, consumers may consume some resources at varying rates (e.g., motorcycles may travel further before re-fueling than sports utility vehicles due to fuel economy); if the consumption rate is available or discernible from the information input in the system, the consumers can be tracked more accurately.

Once the simulation is complete, a user may explore consequences of decisions such as the timing of specific activations (e.g., activating a shelter, placing a barrier or the allocation of resources in system, through the system of the present invention. Furthermore, the user may change parameters of scenario attributes; any changes to such parameters or attributes are imported into the system and the simulation is rerun. Thereby, a user can examine different plans or procedures for handling the event by modifying event parameters and rerunning the simulation.

The system further provides the user with the ability to view the simulation's parameters, as well as data and reports on resource consumption and availability, which may be viewed at the user interface or exported to another program.

The user interface comprises a plurality of layers which can be selected, added or removed from the visual display by means of the layer visibility module. Thereby, a user can see only congestion, or only certain providers, or all congestion and providers.

The system allows playback functionality of simulations along with start, stop, reset, and save capabilities incorporated as a dynamic time-slider. Further, at any time during the simulation playback, the user can select a specific provider and a widget will display the database information regarding that provider and the current resources of that provider at that time stamp (e.g., fuel or beds available).

Furthermore, users may select the type of base map upon which the simulation is visualized. Base maps available to a user may include imagery, imagery with labels, streets, topographic, terrain with labels, light gray canvas, national geographic oceans, open street map, Bing Maps aerial, Bing Maps hybrid and Big Maps Road.

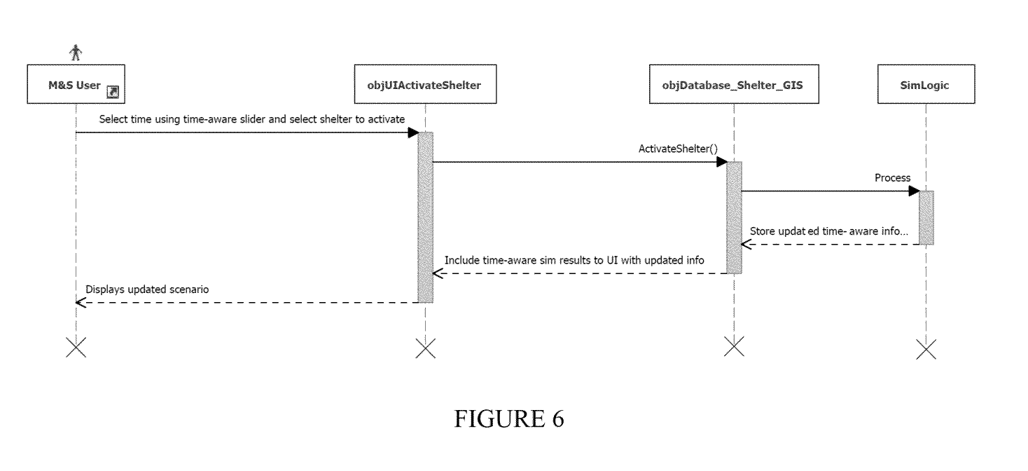

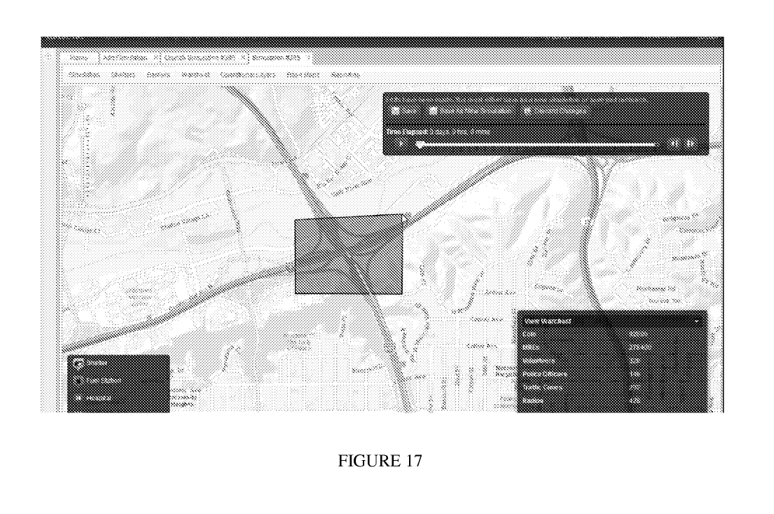

User interfaces are provided in the system so that users can modify the scenario parameters by modifying the transportation network (e.g., adding and removing road blocks as shown in FIG. 17), defining quarantined zones (disallowing ingress and egress), enforcing fuel or water rationing, and activating and de-activating shelters or other providers at any particular time frame. Certain providers may be activated at different levels. For example, as shown in FIG. 6, a shelter may be activated as a long term or short term shelter, which will cause it to use different resources. Some providers may also have a delay attribute, wherein they do not receive consumers until the delay has passed (e.g., waiting for required supplies to be delivered to open shelter, etc.). The delivery of supplies to activate a resource such as a shelter, to refuel a fuel station, or to activate a barrier, can also be modeled by confining delivery vehicle(s) originating from any number of specified dispatch location(s) to the simulation congestion modeling logic so that supplies are delivered when the delivery vehicle(s) are able to reach the intended location (e.g., shelter, fuel station, or barrier location). Further, by means of a map widget embedded within a scenario parameter screen, a user is able to activate and deactivate any specific shelters (or all shelters in an area defined by an expanding polygon created by the user) and place and remove road barriers (by blocking a single point or by using a polygon tool to block an area as defined by the user) at any time-stamp of the simulation. A listing of all shelter names, addresses and activation times may be set forth in a pane of the user interface. The modified information (with time stamp) is sent to the system's simulation logic as a parameter. Because the scenario parameters portion of the portal enables the user to select which shelters are active during the simulation startup, the symbology for active/inactive status should be intuitive (e.g., gray shelter symbology indicates inactive, green shelter symbology indicates high availability, yellow indicates reduced availability and red indicates limited or no availability). The evacuation can then be re-run through the system's simulation geo-processing services, and a modified simulation will be provided to the user in the same format as the original simulation.

The system portal includes a dynamic war chest, including parameter data gathered from the user and depletion thereof during simulation. As hereinabove provided, the activation of a provider or the placement of a barrier has a pre-determined cost charged against the war chest (which pre-determined cost is input by the user or determined from other information gathered from a user—for example, the cost may increase based upon the known or potential occupancy of the shelter). The cost of a provider may be two-tiered, wherein the activation of a provider may have a specific cost, and the shelter may further have a per-occupant cost charged as occupants arrive. If there are insufficient supplies in the war chest to take the requested action, the system alerts the user that there are insufficient resources to complete the request. The user may deactivate shelters and reallocate those resources following the same rules as described.

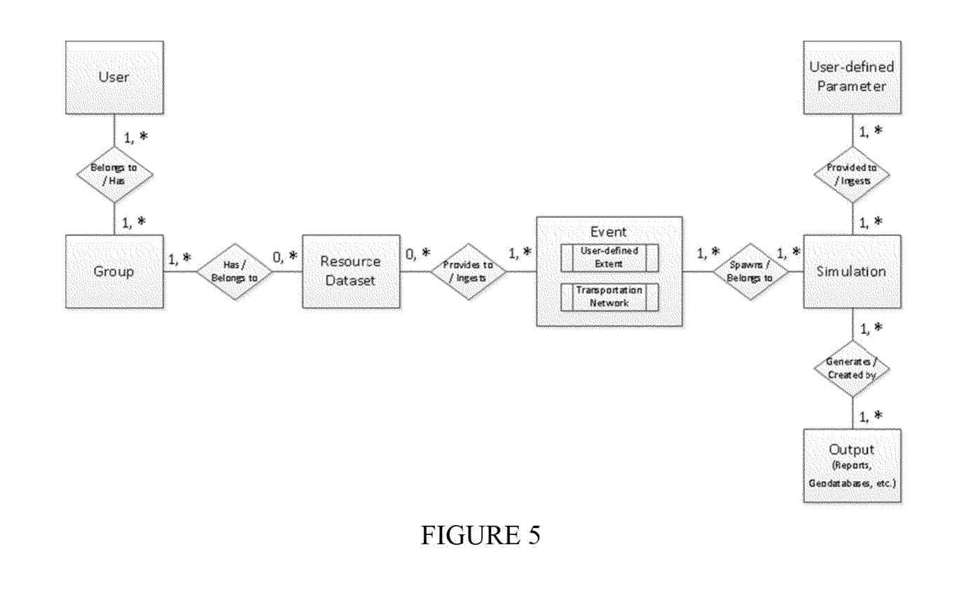

The system supports role based authentication enabling users to be assigned roles and be part of groups. Role based authentication enforces data access rights. The system has menus for managing role based authentication functionality (users, groups, roles), and the system has menus for data access (simulations, data, etc). FIG. 5 shows an entity relationship diagram with the user/system interaction. Specifically, it shows that a user belongs to a group or multiple groups and those groups have data sets that can be exclusive to each specific group. Data sets are provided to the system to define the resources that will be utilized for an event. The event extents are defined by the user. Once the data sets have been ingested into the event, simulations can then be computed based on the provided data set information and event extents. User-defined parameters are provided to the simulation and the simulation generates outputs such as reports, geodatabases, and additional analytical functionality.

Users can choose from a menu of role based saved simulations and data to review and use for the creation of new simulations, review, and comparison purposes

Other objects within the system's user interface include a simulation's parameters information sidebar, an interactive map widget enabling the user to interact and edit any input and output of the simulation logic, and supporting tools including base map selection, live maps, and/or analytical tools. Specifically, the simulation parameters information sidebar includes a summary of the parameters as entered, including how many people are involved, how many vehicles are involved, whether there is congestion, what the water consumption averages are, fuel station information, hospital information, shelter based cost and shelter cost per occupant.

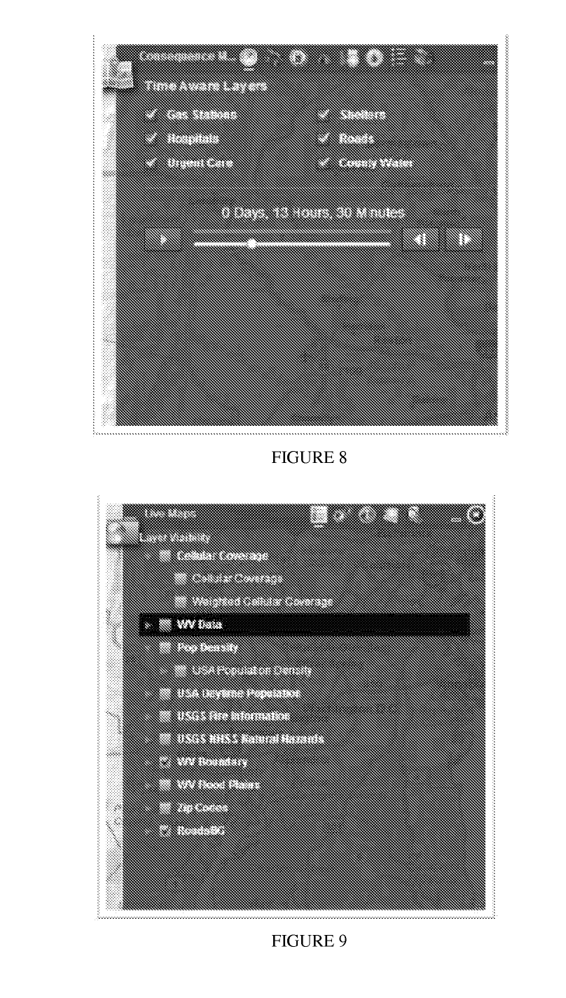

The system (FIG. 8) includes multiple time-aware layers, allowing a user to view only certain providers, or enhanced information. Providers can be selected or deselected at this screen, and based upon the time that they are deselected, at that point they will no longer provide new services. The live maps window further allows a user to add additional information to the maps, as shown in FIG. 9, for example.

Further, the system of the present invention allows a user to compare simulations by resource consumption or otherwise. These comparisons may be displayed in bar charts, and may report stranded consumers.

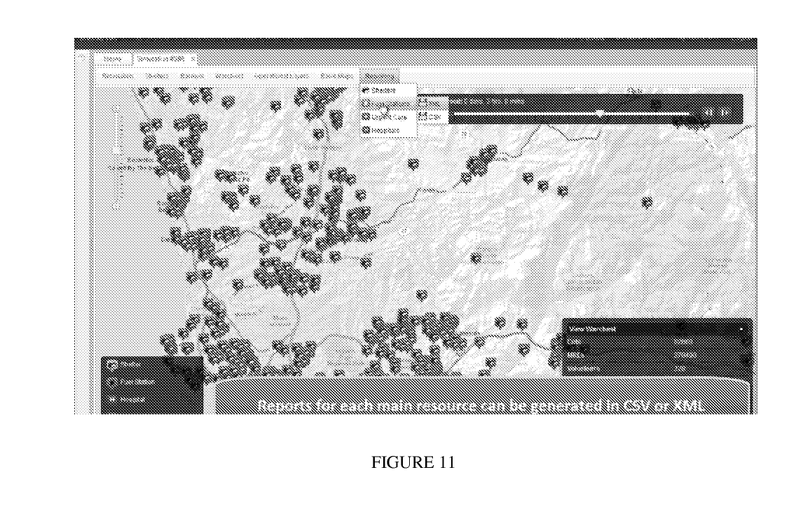

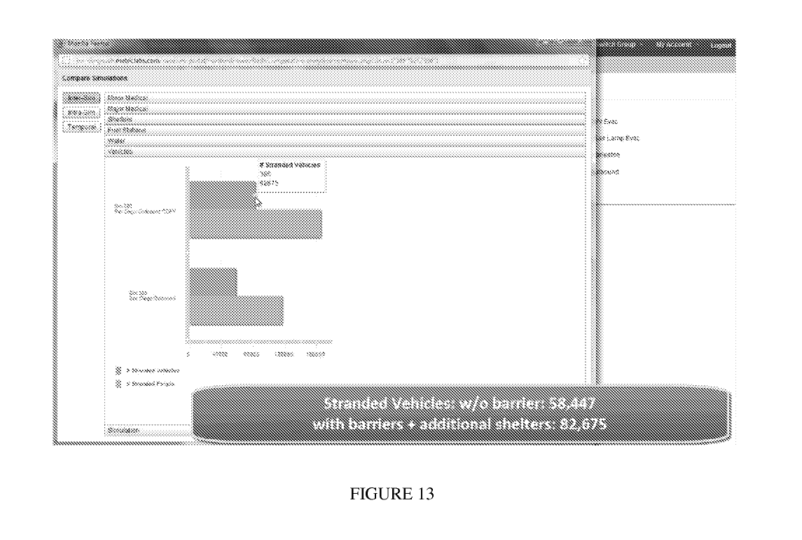

Additionally, the system can be configured to automatically run many iterations of simulations, by means of Monte Carlo or other computational techniques, by automatically modifying event and/or scenario values so that the system can identify specific combinations and timing of actions to achieve a desired user goal (e.g., maximize shelter usage with limited resources, or minimize time during a evacuee migration on transportation network, etc.) Additionally, the system allows users to generate temporal reports for specific resources (e.g. available beds in a hospital over time), or broader reports encompassing all resources and their depletion rates. These reports may be accessed within the system (See, e.g., FIGS. 13, 11) or exported into another format (e.g., .pdf, excel, or word).

In developing the simulation based upon event parameters, the system of the present invention creates and analyzes custom road networks of varying scales and complexities, allowing rerouting and customization. Referring back to FIG. 1, at GP Service 4, the system creates road segments in the event workspace of the system's geo-database as geographically defined and limited by the user; at GP Service 5 all resource data within the boundaries of the simulation is aggregated in the event workspace; and at GP Service 6 the system generates ingress and destination points and stores those in the event workspace. Upon completion of the workspace the user is provided an opportunity to validate ingress and destination points via GP Service 7. In order to model transportation, the system of the present invention generates routes for every possible route from the event location to the destinations such as to population centers and/or points of egress at the edges of geographical boundaries of the workspace of the simulation. Finally, at GP Service 8 the simulation is calculated based on event data and parameters, as well as ingress and egress points and other data available to the system.

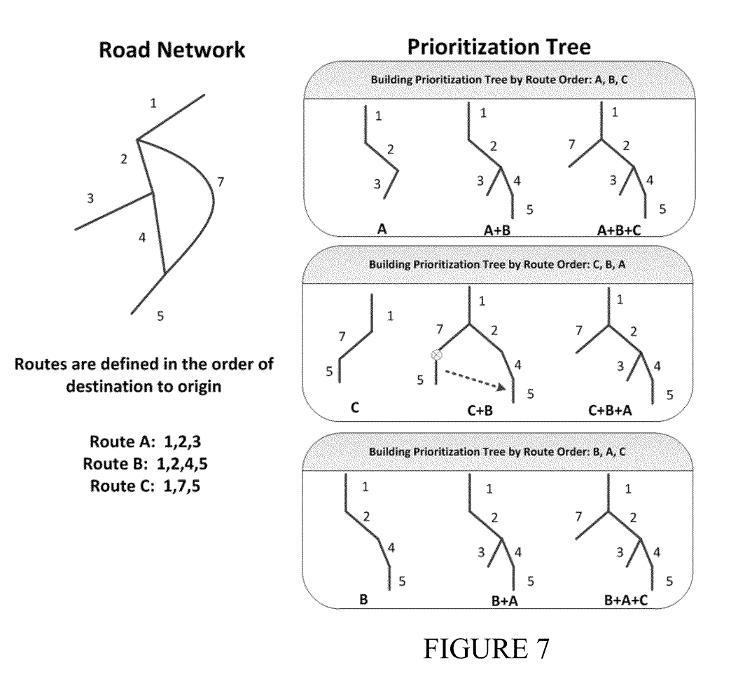

Once the geo-processing Step 7 generates each route, geo-processing Step 8 (in addition to other tasks) builds the route prioritization tree as depicted in FIG. 7 wherein routes are preferably defined in the order of destination to origin. As seen in this figure, for a road network consisting of segments 1-7, unique routes are defined by combining segments (route A=segments 1, 2, 3, route B=segments 1, 2, 4, 5, route C=1, 7, 5). During simulation run time, consumers (such as vehicles) are simulated traversing the route assigned to each vehicle. To avoid deadlock, a prioritization tree is developed to properly process the network segments in the appropriate order. FIG. 7 illustrates three cases for creation of the prioritization tree. Segments from each route are added to the prioritization tree, taking note of the topology or ancestry of each segment with respect to other segments within the route and the overall prioritization tree. Segments are added to the route node in the order of the route (from route destination to route origin). As each segment of the route is processed, the system checks to see if the segment currently exists in the tree.

Beginning with route A, segment 1, the prioritization tree is empty. Segment 1 is added to the route node of the prioritization tree. Next segment 2 of route A is processed. Since segment 2 is the child of segment 1, the tree is traversed and segment 2 is added as the child of segment 1. The same process is followed for segment 3 and this segment is added as a child of segment 2.

The system then processes route B and adds each of its segments to the existing prioritization tree. Starting at segment 1, because this segment already exists in the tree and its parent is null there is no need to add segment 1 again to the tree. Process B's segment 2 also already exists so no action is needed. The system then processes B's segment 4 and determines that the segment 4 does not exist in the tree, and it is added as a child of segment 2. The system then processes B's segment 5, and determines that segment 5 does not exist in the tree and adds it as a child of segment 4.

Similarly, route C is processed; segments 7 and 5 of route C are added in the same manner as described above (segment 1 already existing). The system then compares the level or ancestry count to the route of segment 5 with respect to route C and with respect to the existing prioritizing tree. In route B, segment 5 is the fourth segment; in route C, segment 5 is the third segment. When comparing levels or ancestry for the segment, the option with the highest value (in the present example the fourth segment trumps the third segment), thereby determining where the segment will be located within the tree. If the lower count level were selected, knowing that the tree is processed at run time in breadth first order, segments of the route would be “ahead” or “down the road” from current segments would not be processed before current segments, therefore agents could not move forward resulting in a deadlock condition. During simulation runtime, the tree is traversed in breadth first order which will ensure that parent road segments are logically processed before their children to avoid deadlock conditions.

Further, rather than merely logging cars on a transportation network, the simulation of the present invention can be run based on consumer driven logic such as percent of people seeking major medical or minor medical care.

Because roads have a limited resource of available space, an average car length (e.g., 20 ft.) is used to determine maximum capacity of road segments. For example, a one mile stretch of road (5,280 feet/20 feet per car) yields 264 cars bumper to bumper. This approach can be used to determine road congestion at each time stamp. Further, if a road segment has space for a car, the car can proceed to that segment; if the segment does not have space available, the car cannot proceed.

Route creation logic is integrated into the system to make generated groups aware of master road network table segment IDs. For example, if a generated route starts on a major interstate and turns into a local route, each segment of the generated route will reference the master table so that the system can tally the number of vehicles on a specific road segment at each time iteration. Simulation logic can be used to tally the number of cars on each road segment and the segment totals can be used to generate the heat map time-aware template.

The congestion modeling is based on user defined ingress/egress, route weighting, number of vehicles per hour, fuel consumption, fuel fill-up delays, medical treatment delays, and can be extended, for example, to incorporate weather based delays on a per vehicle level and bridge capacity and overpass/tunnel height constraints. Further, the geo-processing service asynchronously recomputes routes based on barriers that may be implemented into the scenario. Because the user is able to modify routing parameters, such as the number of people per car, miles per gallon, fuel capacity, the system only re-computes a portion of the simulation when barriers are introduced without needing to re-compute the entire routing portion of the simulation.

The system of the present invention is extensible to add additional resources as required, applied to large or small regions, and additional analysis based on the resources, such as determining the effect of mass ingress on fuel, water, first aid, and shelter resources.

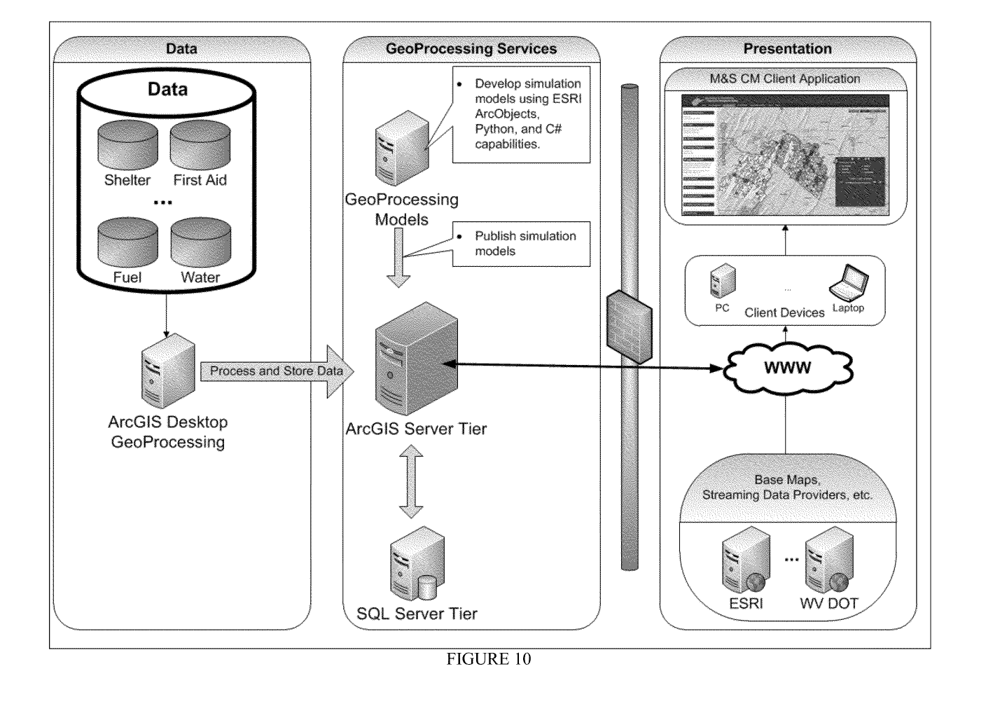

Present systems helpful in the generation of the system of the present invention include GIS software such as ESRI ArcGIS Desktop, used to create the maps and models that will be published onto one or more geoprocessing servers. The geoprocessing server communicates with one or more server databases for data storage and retrieval. Geoprocessing models on the geoprocessing Server utilize the stored data from an SQL Server Database in the simulation process. The geoprocessing server communicates with client devices through the web to display outputs and receive inputs. The geoprocessing server can use outside third party data on the web that can be integrated into the user interface displayed on the client devices. The system design is shown generally in FIG. 10.

Further, the system allows the creation of “template” simulations to allow for a more rapid user interaction with the simulation, whereby the system pre-caches route creation.

### EXAMPLE

As an example of use of the system of the present invention, a user enters his or her user name and password combination and logs into the M&S system. The system validates the combination and allows the user to proceed. To begin a new simulation, user imports data (if desired) and performs field mapping to map attributes of imported data with fields required by the system. The field mapping occurs via an web browser user interface and the field mapping information is stored within the system. If the imported data does not contain fields relevant to the required system fields, the user is able to specify default values by entering a single value or other means such as entering an equation, or linking to a tool or service to specify default values for missing information. The user then can create a new event and specifies the data to use (hospitals, shelters, etc), the type of event (inbound or outbound), ingress/egress speed limits, draw or import the polygons for inbound or outbound event specified, select population center filters (e.g., by size or types of available infrastructure), filter ingress/egress points and population centers that met criteria specified, and name the event data. When the user saves the event, the system uses the GIS server(s) to processes the routes and packages all data into the event workspace (geodatabase). To begin a new simulation session, the user chooses the event workspace to use and then provides starting parameters. Specifically, the user selects “start new simulation” once they have successfully logged into the system. The user modifies the parameters by populating parameter fields or selecting predefined “scenario event type” (e.g., nuclear attack) or using a previous simulation's parameters as a base. The system then displays a list of input parameters that may be modified by the user. The user can change any parameters as they see fit. The user selects “save”, and the system ingests the input parameters and calculates the simulation. If the user desires to select a previous saved simulation run to analyze and review, after logging in the user selects “all simulations” or “my simulations” tab. The system displays a list of saved simulation runs, and the user selects the saved simulation run from the list by selecting “launch”. The system retrieves information (parameters, map, reports), associated with a selected run, and displays the retrieved information to the user. The user may view parameters used, map, (display traffic, roadblocks, shelters, etc.) and reports. The user may also select specific layer(s) from a list to view within the system application. Users can dynamically toggle layer visibility (e.g., hospitals, shelters, etc) within the system. The user can select or deselect any items, or features, as they desire, and the system retrieves selected information for any item or feature selected and displays corresponding information to the user. The user may also add barriers to roads and thereby redirect traffic at any time-stamp during the simulation. When they add any number of barriers to any number of roads of their choice, the simulation recalculates the routes of all vehicles originally taking the impacted road that is now blocked. To do so, the user selects the barrier menu item, selects “place barrier” at the time stamp desired, and can choose where to place a single barrier (point), a line, a polyline, or a polygon barrier at any specified time resulting in a “time aware” barrier. The barrier becomes active at the time specified by the user or when the necessary supplies arrive from a dispatch point. A line, polyline, or polygon barrier consists of multiple points specified by the user. The point, line, polyline, and polygon barrier options can be user defined (e.g., drawn) within the system or can be imported, such as from a file, output from a tool, or external service. The system adds the barrier to the GIS database for the simulation session and awaits user input to recalculate routes for vehicles. The system recalculates and displays the new route and simulation information based on the introduction of the barrier. Similarly, a user may remove a barrier from a road of their choice and in this instance the simulation recalculates the routes of all vehicles. Users may also activate and deactivate shelters at a specific time-stamp during the simulation for evacuees to take refuge in. To do so, the user need only to select a deactivated shelter and select activate to initiate its activation. The system updates the database information regarding the newly activated shelter and re-computes system simulation.

In order to enable fuel rationing at a specific time-stamp during the simulation and fuel rationing applies to all fuel stations in the selected region. Users can also provide polygon(s) as selection region(s) to choose which fuel stations are affected by the rationing command. Users can provide multiple polygons and apply custom fuel rationing information to any fuel stations in the system. In this instance, the user selects a check box to enable fuel rationing (using the ration amount given at the beginning of the simulation). The system then updates the database and recalculates the simulation. Likewise, fuel rationing may be cancelled at a later time.

Polygons can also be used to select/modify features within the system such as shelters, fuel stations, hospitals, etc. For example, users can use polygons as a selection tool to activate or deactivate shelter. Additionally, polygons can be used to mark areas of power failure, and as such, selects all features within the polygon(s) and set a flag indicating power outage. This information can then be used by the intelligent agents to simulate how the intelligent agents react to the power outage, or other condition(s),

Reference is made herein to examples of consumers, providers, parameters, attributes and other features of this invention; these examples are not intended to limit the scope or application of the system of the present invention, and other (and more or less) consumers, providers, parameters, attributes and features may be used in accordance with the teachings of the present invention.

Further, although terms such as “geo-processing” are used herein, they are not limited to geography, and the same processing may occur when mapping the human vascular system, or other systems, unrelated to geography or cartography.

Further, although the term “polygon” is used herein, they are not limited to any dimension. That is, a polygon described in this application can be used represent any multi-dimensional (2D, 3D, or volumetric) space.

Further, although ESRI technologies are listed in this document, the invention does not rely on ESRI and can utilize virtually any GIS technology providing similar functionality.

Further, although the current embodiment mentions specific APIs and development tools, the system can be implemented utilizing virtually any comparable technology to those listed. Finally, the system of the device of the present invention may be loaded on one or more host computing devices with data storage and logic subsystems (e.g., processors, such as a CPU and/or a GPU); peripheral devices may also be used, as well as one or more mass storage devices, such as a hard disk and/or nonvolatile flash memory, and one or more volatile memory devices. Examples of host computing devices include, but are not limited to, personal computers, mobile computers, wireless computing devices, and servers operating in a cloud environment. Examples of peripheral devices include multifunctional peripheral devices, keyboards, mice, and tablets.

TABLE 1
Simulation Scenario Parameters (including but not limited to)

| | | | Validation | |
|---|---|---|---|---|
| Parameter Label | Parameter Name | Type | Criteria | Tooltip |
| N/A | Id | Unique Integer | Unique | N/A |
| | | (Pri. Key) | | |
| N/A | user_id | Unique Integer | Valid User Id | N/A |
| | | (Foreign Key) | | |
| Name | Name | String | Between 3 and | N/A |
| | | | 200 chars. | |
| Description | Description | FullText | Not empty | N/A |
| Number Of People | num_people | Integer | >0 | Number of people |
| | | | | evacuating from NCR |
| Number Of Compan- | num_companions_majmed | Integer | 0, 1, 2(ALL) | Allow traveling |
| ions Major Medical | | | | companion(s) to stay |
| | | | | with any major med |
| | | | | patient(s) in vehicle |
| People Per Vehicle | ppl_per_vehicle | Integer | Between 1 | Number of people per |
| | | | and 5 | vehicle |
| Average MPG | avg_mpg | Float | >0 | Average miles per gallon |
| | | | | for each vehicle |
| Average Tank Capac- | avg_tank_capacity | Float | >0 | Average fuel tank size |
| ity | | | | for each vehicle |
| | | | | (gallons) |
| Fuel Level Begin | fuel_level_begin_searching | Float | 0 . . . 100 | Fuel level threshold to |
| Searching | | | | begin searching for fuel. |
| | | | | i.e., 20% means that the |
| | | | | vehicle begins looking |
| | | | | for fuel when the fuel |
| | | | | level for the vehicle is |
| | | | | 20% or less of the |
| | | | | vehicle tank capacity |
| Ingress Fuel Level | ingress_fuel_level | Float | 0 . . . 100 | Fuel level of incoming |
| | | | | vehicles based on |
| | | | | percentage of vehicle |
| | | | | tank capacity. i.e. 100% |
| | | | | represents full tank of |
| | | | | fuel, 0% represents |
| | | | | empty tank of fuel |
| Fuel Capacity On | fuel_capacity_on_hand | Float | 0 . . . 100 | Percentage of fuel |
| Hand | | | | available for sale based |
| | | | | on total tank capacity. |
| | | | | .i.e. 100% means fuel |
| | | | | station is fully stocked |
| | | | | with fuel |
| Fuel Rationing | fuel_rationing | Boolean | 0, 1 | N/A |
| Fuel Rationing | fuel_rationing_amt | Float | >0 | Number of gallons each |
| Amount | | | | vehicle is allowed to |
| | | | | purchase per fuel |
| | | | | station |
| Congestion Modeling | Congestion | Boolean | 0,1 | N/A |
| Fuel Search Radius | fuel_search_radius | Float | >0 | Search radius to identify |
| | | | | nearby fuel stations |
| | | | | when seeking fuel |
| Shelter Search Radius | shelter_search_radius | Float | >0 | Search radius when |
| | | | | vehicles are seeking |
| | | | | nearby shelters while |
| | | | | traveling |
| Shelter Class | shelter_class | Enum {0 = | 0, 1 | Specify to use |
| | | ‘PostImpact’, | | Evacuation or Post- |
| | | 1 = ‘Evac’} | | Impact shelter capacity. |
| | | | | Evacuation is based on |
| | | | | 20 sq. ft per person. |
| | | | | Post-Impact is based on |
| | | | | 40 sq. ft per person |
| Hospital Search | hospital_search_radius | Float | >0 | Search radius when |
| Radius | | | | vehicles are seeking |
| | | | | hospitals while traveling. |
| | | | | Hospitals can treat major |
| | | | | and minor injuries. |
| Minor Medical Search | minormed_search_radius | Float | >0 | Search radius when |
| Radius | | | | vehicles are seeking |
| | | | | treatment facilities for |
| | | | | minor medical |
| | | | | treatment while |
| | | | | traveling. Hospitals, |
| | | | | activated shelters, and |
| | | | | urgent care facilities can |
| | | | | treat minor medical |
| | | | | injuries |
| Spawn Size | spawn_size | Integer | >0 | Number of vehicles |
| | | | | spawned at Ingress per |
| | | | | minute ingress interval |
| Percent Needing | percent_needing_shelter | Integer | 0 . . . 100 | % of evacuees seeking |
| Shelter | | | | shelter within the event |
| | | | | region. Combination |
| | | | | must total 100%. |
| Percent Traveling | percent_traveling_friend | Integer | 0 . . . 100 | % of evacuees seeking |
| Friend | | | | shelter at friend/relative |
| | | | | residence within the |
| | | | | event region. Combina- |
| | | | | tion must total 100%. |
| Percent Migrating | percent_migrating_through | Integer | 0 . . . 100 | % of evacuees not |
| Through | | | | seeking shelter in event |
| | | | | region. Combination |
| | | | | must total 100%. |
| Percent Needing | percent_needing_majmedical | Float | 0-100 | % of evacuees needing |
| Major Medical | | | | major medical assistance |
| Percent Needing | percent_needing_minmedical | Float | 0-100 | % of evacuees needing |
| Minor Medical | | | | minor medical assistance |
| Average Water Per. | avg_water_per_shelter_occ | Float | >=0 | Average gallons/hr used |
| Shelter Occupant | | | | per shelter occupant |
| Average Water Per. | avg_water_per_hospital_pat | Float | >=0 | Average gallons/hr used |
| Hospital Patient | | | | per hospital patient |
| Average Water Per. | avg_water_per_minormed_pat | Float | >=0 | Average gallons/hr used |
| Minor Medical Patient | | | | per minor medical |
| | | | | patient |
| Average Water Per. | avg_water_per_fuelstation_visit | Float | >=0 | Average gallons used |
| Fuel Station Visit | | | | per fuel station visit |
| Baseline Water Usage | baseline_water_usuage | Integer | >=0 | Amount of water used |
| | | | | by local residents on a |
| | | | | regular basis |
| Average Number Of | avg_beds_available | Float | 0 . . . 100 | Percentage of beds |
| Beds Available | | | | available for patient use |
| Delay Fuel | delay_fuel | Integer | >=0 | The time in minutes to |
| | | | | delay the vehicle at the |
| | | | | fuel station (e.g., 30) |
| Delay Minor Medical | delay_minormed | Integer | >=0 | The time in minutes to |
| | | | | delay the vehicle at an |
| | | | | urgent care station |
| | | | | (e.g., 60) |
| Idle Fuel Consumption | idle_fuel_consumption | Float | >=0 | Idle Fuel Consumption |
| | | | | in gallons, per minute |
| | | | | (e.g., 0.01) |
| Shelter Cost | shelter_cost | JSON Serial- | | N/A |
| | | ized Object | | |
| Shelter Per Occupant | shelter_occ_cost | JSON Serial- | | N/A |
| Cost | | ized Object | | |
| Barrier Cost | barrier_cost | JSON Serial- | | N/A |
| | | ized Object | | |
| Global Resources | global_resources | JSON Serial- | | N/A |
| | | ized Object | | |
| Selected Shelters | shelters | JSON Serial- | | N/A |
| | | ized Object | | |
| Selected Barriers | Barriers | JSON Serial- | | N/A |
| | | ized Object | | |
| Ingress Weights | ingress_weights | JSON Serial- | | N/A |
| | | ized Object | | |
| Template | Template | Boolean | | Use this scenario as a |
| | | | | template? |
| Created | Created | DateTime | | N/A |
| Force ReRoute | force_reroute | Boolean | 0, 1 | |

TABLE 2
Resource Field Information (such as but not limited to)

| | | | | Sup- |
|---|---|---|---|---|
| Resource Type | Field Name | Field Type | Derived | plied |
| FUEL | Shape | DEFAULT | X | |
| | TimeStamp | DATE | X | |
| | StampNum | LONG | X | |
| | FuelRem | DOUBLE | X | |
| | PercRem | DOUBLE | X | |
| | WaterUsed | DOUBLE | X | |
| | Address | TEXT | | X |
| | City | TEXT | | X |
| | State | TEXT | | X |
| | County | TEXT | | X |
| | TotalFuel | LONG | | X |
| | Name | TEXT | | X |
| SHELTERS | SpaceRemPost | DOUBLE | X | |
| | ShelterId | TEXT | X | |
| | ShelterStatus | TEXT | X | |
| | StampNum | LONG | X | |
| | Timestamp | DATE | X | |
| | Shape | DEFAULT | X | |
| | PercRem | DOUBLE | X | |
| | WaterUsed | DOUBLE | X | |
| | SpaceRemEvac | DOUBLE | X | |
| | EvacMinorMed | LONG | | X |
| | PostMinorMed | LONG | | X |
| | | | | X |
| | | | | X |
| | Address | TEXT | | X |
| | City | TEXT | | X |
| | State | TEXT | | X |
| | County | TEXT | | X |
| | Name | TEXT | | X |
| | SpaceCapEvac | LONG | | X |
| | SpaceCapPost | LONG | | X |
| HOSPITALS | WaterUsed | DOUBLE | X | |
| | BedsRem | LONG | X | |
| | NumCars | LONG | X | |
| | NumCohorts | LONG | X | |
| | MinorMed | LONG | X | |
| | PercRem | DOUBLE | X | |
| | TimeStamp | DATE | X | |
| | StampNum | LONG | X | |
| | Shape | DEFAULT | X | |
| | Address | TEXT | | X |
| | City | TEXT | | X |
| | State | TEXT | | X |
| | County | TEXT | | X |
| | NumBeds | LONG | | X |
| | MaxMinorMedical | LONG | | X |
| | Name | TEXT | | X |
| | MaxNumPaitents | LONG | | X |
| URGENT | PercRem | DOUBLE | X | |
| CARE | Timestamp | DATE | X | |
| | StampNum | LONG | X | |
| | Shape | DEFAULT | X | |
| | CareRem | LONG | X | |
| | WaterUsed | DOUBLE | X | |
| | Address | TEXT | | X |
| | City | TEXT | | X |
| | State | TEXT | | X |
| | County | | | X |
| | Name | TEXT | | X |
| | MaxNumPatients | LONG | | X |
| WATER | OnHandCapacity | LONG | X | |
| | ProductionPerHour | LONG | X | |
| | PercRem | DOUBLE | X | |
| | TimeStamp | DATE | X | |
| | StampNum | LONG | X | |
| | Shape | DEFAULT | X | |
| | CurConsumption | DOUBLE | X | |
| | Name | TEXT | | X |

We claim:

1. A modeling and simulation system comprising means to track consumers on a transportation network as individual agents, whereby the consumers consume resources from providers mapped on a geographic map.
